(19) United States
(12) Patent Application Publication
(10) Pub. No.: US 2026/0254564 A1
(43) Pub. Date: Aug. 27, 2026

(54) METHOD, DEVICE AND COMPUTER READABLE MEDIUM FOR SIDELINK COMMUNICATION

(71) Applicant: NEC Corporation, Tokyo (JP)

(72) Inventors: Zhaobang MIAO, Beijing (CN); Jin YANG, Beijing (CN); Ying ZHAO, Beijing (CN); Gang WANG, Beijing (CN)

(73) Assignee: NEC Corporation, Tokyo (JP)

(21) Appl. No.: 18/879,422

(22) PCT Filed: Jul. 1, 2022
(86) PCT No.: PCT/CN2022/103431

§ 371 Date: Dec. 27, 2024

(51) Int. Cl. H04L 1/1812; H04W 72/25

(52) U.S. Cl. CPC H04L 1/1812; H04W 72/25

(57) ABSTRACT

Embodiments of the present disclosure relate to method, device and computer readable media for sidelink communication. A method implemented for sidelink communication comprises: selecting, at a first terminal device for a plurality of different transport blocks (TBs) with each TB associated with a sidelink hybrid automatic repeat request (HARQ) process, a first plurality of resources in a first plurality of consecutive slots. The method also comprises transmitting to at least one other terminal device the plurality of different TBs on the first plurality of resources.

### TECHNICAL FIELD

Embodiments of the present disclosure generally relate to the field of telecommunication, and in particular, to a method, device and computer readable media for sidelink communication.

### BACKGROUND

Sidelink in unlicensed spectrum or band (SL-U) is to be studied in Release 18 sidelink evolution work item of the 3rd Generation Partnership Project (3GPP). The scheme of SL-U should be based on New Radio (NR) sidelink and NR-U.

In sidelink communication, there are two modes of resource allocation. In a first mode (also referred to as NR sidelink mode 1 or mode 1 hereinafter), one terminal device may perform sidelink communication with the other terminal device by using resources allocated by a network device. In a second mode (also referred to as NR sidelink mode 2 or mode 2 hereinafter), one terminal device may perform sidelink communication with the other terminal device by using resources autonomously selected in a resource pool by the one terminal device.

### SUMMARY

In general, example embodiments of the present disclosure provide methods, devices and computer readable media for sidelink communication.

In a first aspect, there is provided a method for sidelink communication. The method comprises: selecting, at a first terminal device for a plurality of different transport blocks (TBs) with each TB associated with a sidelink hybrid automatic repeat request (HARQ) process, a first plurality of resources in a first plurality of consecutive slots. The method also comprises transmitting to at least one other terminal device the plurality of different TBs on the first plurality of resources.

In a second aspect, there is provided a method for sidelink communication. The method comprises: in response to determining, at a first terminal device based on a predefined condition, that an initial transmission and at least one retransmission of a transport block (TB) are allowed to be transmitted in consecutive slots, selecting a plurality of resources in a plurality of consecutive slots for the initial transmission and the at least one retransmission of the TB. The method also comprises transmitting to a second terminal device the initial transmission and the at least one retransmission of the TB on the plurality of resources.

In a third aspect, there is provided a terminal device. The terminal device comprises a processor configured to perform the method according to the first aspect or the second aspect.

In a fourth aspect, there is provided a computer readable medium having instructions stored thereon. The instructions, when executed on at least one processor of a device, cause the device to perform the method according to the first aspect or the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates an example signaling chart showing an example process of multi-slots transmission for a plurality of different TBs in accordance with some embodiments of the present disclosure;

FIG. 3 illustrates an example of multiple SL process associated with a plurality of different TBs in accordance with some embodiments of the present disclosure;

FIG. 4 illustrates an example of resource selection for multi-slots transmission in accordance with some embodiments of the present disclosure:

FIG. 5 illustrates another example of resource selection for multi-slots transmission in accordance with some embodiments of the present disclosure;

FIG. 6 illustrates an example of an enhanced SCI with a slot duration field indicating resources in consecutive slots in accordance with some embodiments of the present disclosure;

FIG. 7 illustrates another example of an enhanced SCI with a slot duration field indicating resources in consecutive slots in accordance with some embodiments of the present disclosure:

FIG. 8A illustrates an example of resource reservation indicated in SCI from other UE in accordance with some embodiments of the present disclosure;

FIG. 8B illustrates an example of resource exclusion for the resource reservation in FIG. 8A, in accordance with some embodiments of the present disclosure:

FIG. 9A illustrates an example of resource reservation indicated in SCI from other UE in accordance with some embodiments of the present disclosure:

FIG. 9B illustrates an example of resource exclusion for the resource reservation in FIG. 9A, in accordance with some embodiments of the present disclosure;

FIG. 9C illustrates another example of resource exclusion for the resource reservation in FIG. 9A, in accordance with some embodiments of the present disclosure:

FIG. 10 illustrates a flowchart of an example method of multi-slots transmission for a TB in accordance with some embodiments of the present disclosure;

FIGS. 11A-11C illustrate examples of resource selections for multi-slots transmission for a TB in accordance with some embodiments of the present disclosure;

FIG. 12 illustrates an example of an SCI without a slot duration field indicating resources in consecutive slots in accordance with some embodiments of the present disclosure;

FIG. 13 illustrates the frequency resource distribution in a slot as used herein;

FIG. 14 illustrates a flowchart of an example method implemented at a terminal device in accordance with some embodiments of the present disclosure;

FIG. 15 illustrates a flowchart of another example method implemented at a terminal device in accordance with some embodiments of the present disclosure; and

FIG. 16 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The “terminal device” can further has “multicast/broadcast” feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “at least in part based on.” The term “some embodiments” and “an embodiment” are to be read as “at least some embodiments.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum.” or the like. It will be appreciated that such descriptions are intended to indicate that a selection among many used functional alternatives can be made, and such selections need not be better, smaller, higher, or otherwise preferable to other selections.

As mentioned above, the scheme of SL-U should be based on NR sidelink and NR-U. For example, channel access mechanisms from NR-U may be reused for sidelink unlicensed operations. Moreover, the existing NR sidelink and NR-U channel structure shall be reused as the baseline for physical (PHY) channel design framework of SL-U. Currently, channel access, resource allocations and PHY channel designs are still open, such as the impacts on resource selections, sidelink control information (SCI) designs, sensing procedures, etc.

Embodiments of the present disclosure propose a method for sidelink communication. In this solution, at least the following developments for multi-slots transmissions in SL-U are provided: resource selections for multi-consecutive slots transmission, an enhanced SCI structure to indicate consecutive resources, and sensing procedure adjustments of UE. Multi-slots transmissions described herein can be also referred as multi-consecutive slots transmission (also often referred as burst, back-to-back or just multi-slot transmission) in Rel-18 for sidelink operations in the unlicensed spectrum.

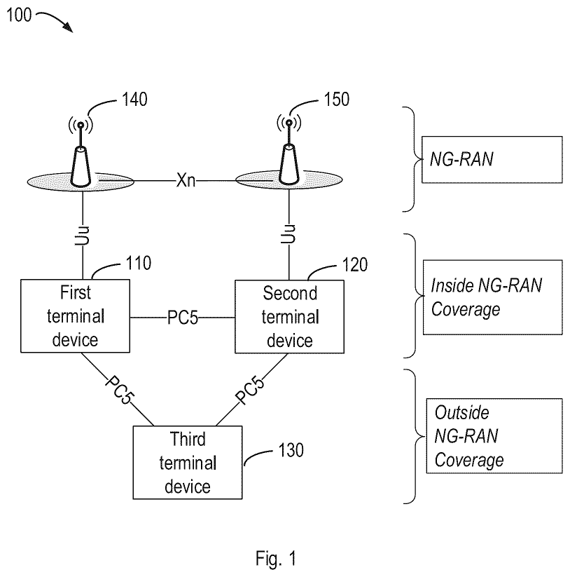

Principle and implementations of the present disclosure will be described in detail below with reference to FIGS. 1 to 16. FIG. 1 illustrates a schematic diagram of an example communication network 100 in which embodiments of the present disclosure can be implemented. As shown in FIG. 1, the communication network 100 may include a first terminal device 110, a second terminal device 120, a third terminal device 130, network devices 140 and 150. The network devices 140 and 150 may communicate with the first terminal device 110, the second terminal device 120 and the third terminal device 130 via respective wireless communication channels.

In some embodiments, the network device 140 may be a gNB in NR, and the network device 150 may be an eNB in Long Term Evolution (LTE) system.

It is to be understood that the number of devices in FIG. 1 is given for the purpose of illustration without suggesting any limitations to the present disclosure. The communication network 100 may include any suitable number of network devices and/or terminal devices adapted for implementing embodiments of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the first terminal device 110, the second terminal device 120 and the third terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the first terminal device 110) to a target terminal device (such as the second terminal device 120) through the Unified Air Interface, e.g., PC5 interface, (i.e., sidelink transmissions), as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

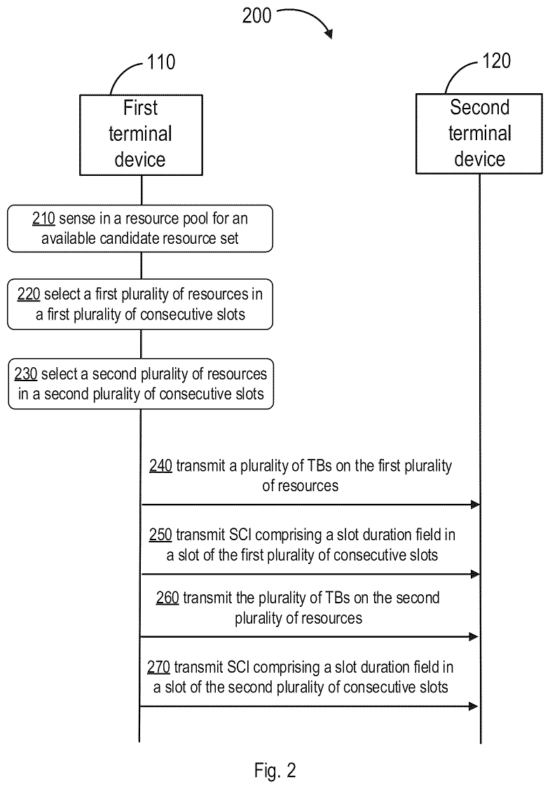

FIG. 2 illustrates an example signaling chart showing an example process 200 of multi-slots transmission for a plurality of different TBs in accordance with some embodiments of the present disclosure. For the purpose of discussion, the process 200 will be described with reference to FIG. 1. The process 200 may involve the first terminal device 110 and the second terminal device 120 as illustrated in FIG. 1. In addition, other terminal devices may be also involved, e.g., the third terminal device 130 in FIG. 1. Although the process 200 has been described in the communication network 100 of FIG. 1, this process may be likewise applied to other communication scenarios.

At block 210, the first terminal device 110 senses in a resource pool for an available candidate resource set. It would be more clearly to describe the resource selections related to the sensing procedure firstly. Thus, before discussing the sensing procedure in detail, the resource selections will be described below.

At block 220, the first terminal device 110 selects a first plurality of resources in a first plurality of consecutive slots.

At block 230, the first terminal device 110 selects a second plurality of resources in a second plurality of consecutive slots. In some embodiments, the first plurality of resources in the first plurality of consecutive slots may be used for initial transmissions (or first transmissions) of a plurality of different TBs. In some embodiments, the second plurality of resources in the second plurality of consecutive slots may be used for retransmissions (or second transmissions) of the plurality of different TBs.

In a normal resource pool where a physical sidelink feedback channel (PSFCH) is configured and hybrid automatic repeat request acknowledge (HARQ-ACK) is enabled by higher layer, a single TB's multiple (re-)transmissions cannot be consecutive considering HARQ-ACK timeline restriction. Note that the TB as used herein may be interchangeably with a media access control protocol data unit (MAC PDU).

A possible situation is one UE's multiple SL HARQ processes associated with different TBs whose transmissions could be consecutive. Accordingly, the first terminal device 110 can select a first plurality of resources in a first plurality of consecutive slots for a plurality of different TBs with each TB associated with a sidelink HARQ process.

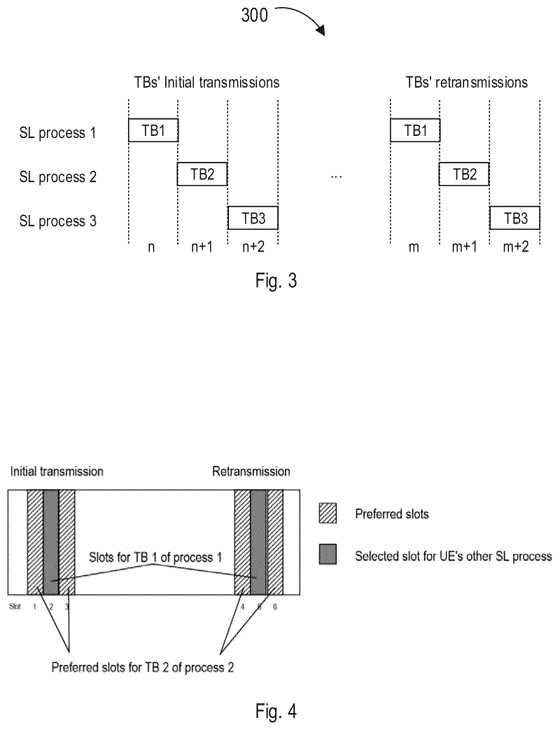

Reference is now made to FIG. 3, which shows an example 3M) of multiple SL process associated with a plurality of different TBs. As shown in FIG. 3, the TB 1, 2, 3 are associated with SL process 1, 2, 3 respectively. For example, initial transmission slots of TB 1, 2, 3 are slots n, n+1, n+2 respectively, which are consecutive, and the retransmissions slots of TB 1, 2, 3 are slots m, m+1, m+2, which are consecutive too. It is to be understood that the numbers of SL process and TBs in FIG. 3 are given for the purpose of illustration without suggesting any limitations to the present disclosure. For a dedicated TB, e.g., TB 1, the resources for initial and retransmission are not required to be consecutive due to HARQ-ACK timeline restriction.

In some embodiments, for each sidelink process, it's up to implementation of UE (e.g., the first terminal device 110) to select resources from the available candidate resource set by ensuring the resources for different TB associated with multiple or all sidelink processes of the UE are consecutive in time domain according to the remaining packet delay budgets (PDB) of the TBs.

Alternatively or in addition, for the current SL process, UE may preferably select resource from the available candidate resource set which is immediately preceding or following the already selected resource for another SL process of the same UE. This will be described with reference to FIG. 4.

FIG. 4 illustrates an example of resource selection for multi-slots transmission in accordance with some embodiments of the present disclosure. As shown in FIG. 4, slot 2 has been selected by UE (e.g., the first terminal device 110) for the initial transmission of the TB 1 of the SL process 1. In this case, the UE may preferably select the immediately preceding slot (i.e., slot 1) or the immediately following slot (i.e., slot 3) for the initial transmission of the TB 2 of the SL process 2. Similarly, slot 5 has been selected by UE for the retransmission of the TB 1 of the SL process 1. In this case, the UE may preferably select the immediately preceding slot (i.e., slot 4) or the immediately following slot (i.e., slot 6) for the retransmission of the TB 2 of the SL process 2. The selected resources should fall into a time length of remaining Channel Occupancy Time (COT) or maximum COT. For example, slot 1, 2 and 3 are within a remaining Channel Occupancy Time (COT) or maximum COT. In this way, different TBs can be transmitted on resources in consecutive slots such that the COT can be retained, resulting in a reduced number of channel accesses and improved channel access efficiency.

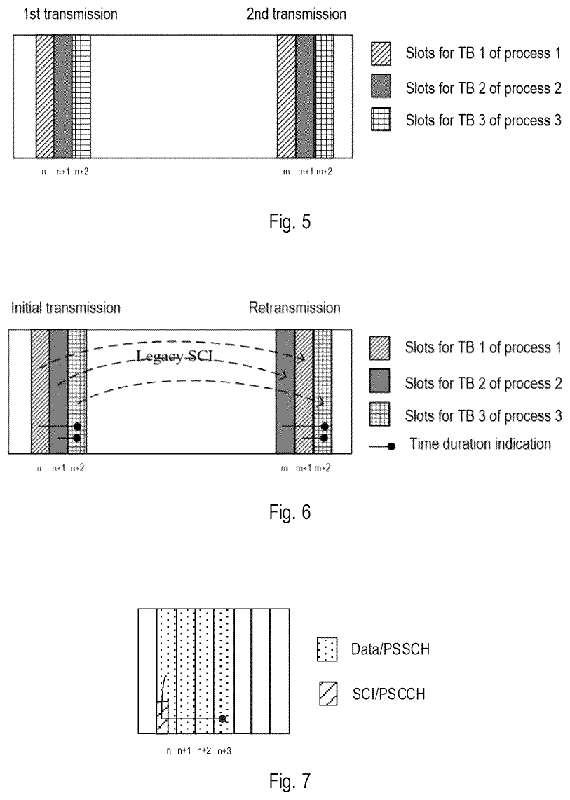

Alternatively or in addition, UE can ensure that the slots order for different processes or MAC PDU in every transmission occasions are consistent. This will be described with reference to FIG. 5.

FIG. 5 illustrates another example of resource selection for multi-slots transmission in accordance with some embodiments of the present disclosure. As shown in FIG. 5, the slots order of the first transmission (e.g., initial transmission) of TB 1, 2, 3 of process 1, 2, 3 is consistent with that of the second transmission (e.g., retransmission) of TB 1, 2, 3 of process 1, 2, 3. In this way, the SCI scheduling for the multi-slots transmission is simplified.

Returning to FIG. 2, at block 240, the first terminal device 110 transmits the plurality of different TBs on the first plurality of resources. In some embodiments, the first terminal device 110 may have different traffic TBs intended to different destinations. For example, the first terminal device 110 may transmit the different traffic TBs to at least one other terminal device (e.g., the second terminal device 120 and/or the third terminal device 130) belonging to different destinations. Alternatively or in addition, the first terminal device 110 may have different TBs belongs to a same big traffic intended to same destination. For example, the first terminal device 110 may transmit the different traffic TBs belonging to a same traffic to at least one other terminal device belonging to a same destination.

Embodiments of the present disclosure also provide an enhanced SCI to indicate the consecutive resources in consecutive slots for different TB's transmissions. A new field “slot duration” or “time duration” which will be used interchangeably with “slot duration” can be added into current SCI format 1-A to indicate the number of subsequent consecutive slots. This will be described with reference to FIG. 6.

FIG. 6 illustrates an example of an enhanced SCI with a slot duration field indicating resources in consecutive slots in accordance with some embodiments of the present disclosure. Legacy SCI can indicate the slots of current (re-)transmission and subsequent retransmissions by a “time resource assignment” field and indicate frequency resources in the slots by a “frequency resource assignment” field. However, for transmissions in consecutive slots, the legacy SCI may be inefficient in terms of indicating resources. The new “slot duration” field provides flexibility and redundancy in indicating resources.

As shown in FIG. 6, the slot duration field in SCI indicates the number of consecutive slots subsequent the slot in which the SCI is transmitted. For example, value of the slot duration field in SCI transmitted in slot n may indicate there are two subsequent consecutive slots selected, and value of the slot duration field in SCI transmitted in slot n+1 may indicate there is one subsequent slot selected. Similarly for the retransmission slots, by adding the slot duration field in SCI, other UE (e.g., the second terminal device 120 and/or the third terminal device 130) could avoid selecting the slots within the consecutive slots burst and there will be more opportunities to select consecutive slots for current UE. In addition to the legacy resource exclusion, other UE could further exclude consecutive slots resource indicated by the slot duration field added in the SCI. For example, for the SCI in slot n+1, other UE could exclude slot n+1, n+2 and slot m, m+1, m+2 (for legacy SCI, only slot m+1 would be excluded).

The bit length of slot duration could be determined according to high layer configuration. Moreover, the allowed slot duration corresponding to each value of “slot duration” could also be RRC configured, e.g., each value of 2bits “slot duration” may corresponding to [0,1,2,3] or [0,2,4,8] [2,4,8,16] etc. Two examples are provided as below, other fields are omitted, and it's understood that the location of the new field may be anywhere in the SCI. Table 1 shows an example change in TS 38.212 associated with the slot duration field.

TABLE 1

| | |
|---|---|
| 8.3.1.1 | SCI format 1-A |

...omitted...

| - | PSFCH overhead indication - 1 bit as defined clause 8.1.3.2 of [6, TS 38.214] if | |
|---|---|---|
| | higher layer parameter sl-PSFCH-Period = 2 or 4; 0 bit otherwise. | |
| - | Slot duration - to indicate the number of subsequent consecutive slots with bit | |
| | length determined by RRC configuration. | |
| - | Reserved - a number of bits as determined by the following: | |
| | - | N_{reserved} bits as configured by higher layer parameter sl-NumReservedBits, |
| | | with value set to zero, if higher layer parameter indicationUEBScheme2 is not |
| | | configured, or if higher layer parameter indicationUEBScheme2 is configured |
| | | to ‘Disabled’; |
| | - | (N_{reserved} − 1) bits otherwise, with value set to zero. |
| - | Conflict information receiver flag - 0 or 1 bit | |
| | - | 1 bit if higher layer parameter indicationUEBScheme2 is configured to |
| | | ‘Enabled’, where the bit value of 0 indicates that the UE cannot be a UE to |
| | | receive conflict information and the bit value of 1 indicates that the UE can be a |
| | | UE to receive conflict information as defined in Clause 16.3.0 of [5, TS |
| | | 38.213]; |
| | - | 0 bit otherwise. |

...

Table 2 shows another example change in TS 38.212 associated with the slot duration field.

TABLE 2

| | |
|---|---|
| 8.3.1.1 | SCI format 1-A |

...omitted...

| - | Reserved - a number of bits as determined by the following: | |
|---|---|---|
| | - | (N_{reserved} − 2) bits as configured by higher layer parameter sl- |
| | | NumReservedBits, with value set to zero, if higher layer parameter |
| | | indicationUEBScheme2 is not configured, or if higher layer parameter |
| | | indicationUEBScheme2 is configured to ‘Disabled’; |
| | - | (N_{reserved} − 1 − bit number of Slot duration ) bits otherwise, with |
| | | value set to zero. |
| | - | Slot duration - 1 or 2 bits to indicate the number of subsequent |
| | | consecutive slots. 1 bit if higher laver parameter indicationUEBScheme2 |
| | | is configured to ‘Enabled’ and sl-NumReservedBits with value set to 2. |
| | | Otherwise, 2 bits. |
| - | Conflict information receiver flag - 0 or 1 bit | |
| | - | 1 bit if higher layer parameter indicationUEBScheme2 is configured to |
| | | ‘Enabled’, where the bit value of 0 indicates that the UE cannot be a UE to |
| | | receive conflict information and the bit value of 1 indicates that the UE can be |
| | | a UE to receive conflict information as defined in Clause 16.3.0 of [5, TS |
| | | 38.213]; |
| | - | 0 bit otherwise. |

...

For a special case where multiple TBs or slot-bundling transmission in consecutive transmissions are intended for same destination (e.g., UE has different TBs belongs to a same big traffic intended to same destination), only one SCI before the multiple slots is also a method. This will be described with reference to FIG. 7.

Returning to FIG. 2, at block 250, the first terminal device 110 may transmit SCI comprising a slot duration field in a slot of the first plurality of consecutive slots. The slot duration field may indicate the number of consecutive slots of the first plurality of consecutive slots subsequent to the slot.

FIG. 7 illustrates another example of an enhanced SCI with a slot duration field indicating resources in consecutive slots in accordance with some embodiments of the present disclosure. To avoid too much impacts to legacy SCI and SCI size limitation, only one SCI may be configured and transmitted in the first one slot n of the multiple consecutive slots (i.e., n to n+3), as shown in FIG. 7. A “time resource assignment” and “frequency resource assignment” may indicate frequency resource in the first one slot, and a time duration field indicates the consecutive slots number.

Then, at block 260, the first terminal device 110 may transmit the plurality of different TBs on the second plurality of resources, and at block 270, the first terminal device 110 may transmit SCI comprising a slot duration field in a slot of the second plurality of consecutive slots.

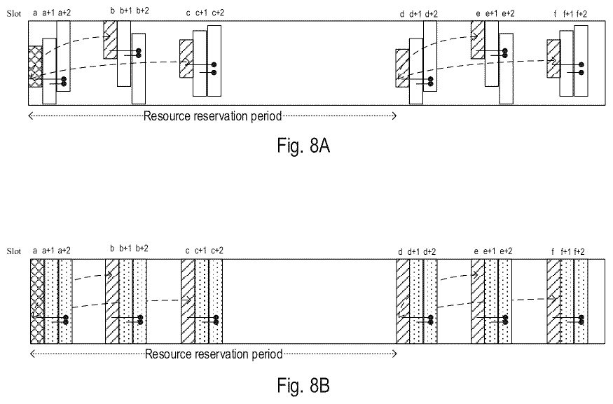

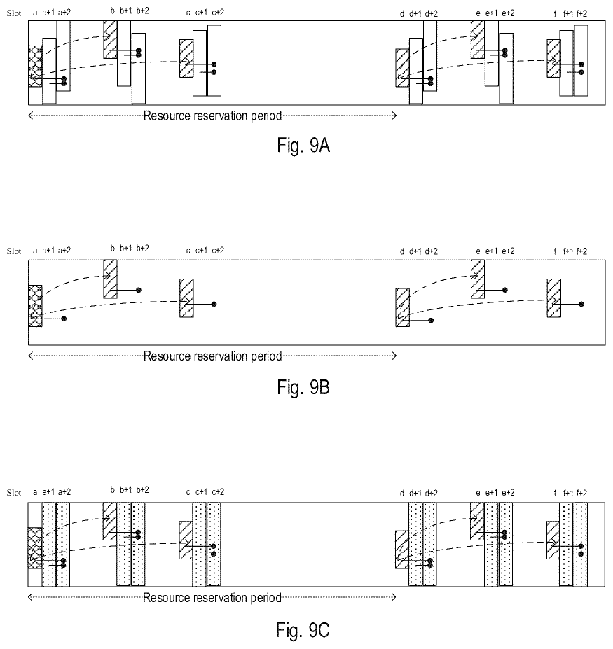

Embodiments of the present disclosure also provide an enhanced sensing procedure for UE to exclude resources. This will be described with reference to FIGS. 8A to 9C.

In some embodiments, if only one UE are allowed to access and perform transmission in one listen before talk (LBT) bandwidth (BW) (i.e., resource block (RB) set or LBT sub-band), i.e., no UE frequency division multiplexed (FDMed) in one RB set, the first terminal device 110 may exclude the whole frequency resources in the slots indicated by the time resource assignment and slots indicated by the slot duration field of the SCI received from other terminal device. This will be described with reference to FIGS. 8A and 8B.

FIG. 8A illustrates an example of resource reservation indicated in SCI received in slot a from other UE in accordance with some embodiments of the present disclosure. As shown in FIG. 8A, the first terminal device 110 may be indicated by the time resource assignment and frequency resource assignment of SCI received from other terminal device (e.g., the second terminal device 120 and/or the third terminal device 130), that part of the frequency resources in slots a, b, c, as well as the corresponding slots d, e, f after a resource reservation period are reserved. The received SCI may further indicate by its slot duration field that a part of the frequency resources in following consecutive slots a+1, a+2, b+1, b+2, c+1, c+2, d+1, d+2, e+1, e+2, f+1 and f+2 are also reserved.

Since no UE FDMed in one RB set, the first terminal device 110 may exclude the whole frequency resources in the slots a, b, c, d, e and f (which are indicated by the time resource assignment) and slots a+1, a+2, b+1, b+2, c+1, c+2, d+1, d+2, e+1, e+2, f+1 and f+2 (which are indicated by the time duration field), as shown in FIG. 8B.

Table 3 shows an example change in TS 38.214 associated with the resource exclusion.

```
TABLE 3
. . . omitted . . .
  The UE shall exclude any candidate single-slot resource _R_{y}_ from
  the set S_{A} if it meets all the following conditions. A candidate
  single-slot resource for transmission R_{y} is defined as all the
  $frequency resource in slot {t}_{y}^{′ SL} .$
    a), b) are omitted
    $c ) the SCI format received in slot {t}_{m}^{′ SL} or the same SCI$
    format which, if and only if the ′Resource reservation period′
    field is present in the received SCI format 1-A, is assumed to
    $be received in slot ( s ) {t}_{m + q \times {P}_{rsvp , RX}^{′}}^{′ SL} determines according$
    to clause 8.1.5X the set of slots which overlaps with
    ${R}_{y + j \times {P}_{rsvp \_ TX}^{′}} for q = 1 , 2 , … , Q and j = 0 , 1 , … , {C}_{resel} - 1 .$
    --- omitted ---
    Clause 8.1.5X
      The set of slots and resource blocks for PSSCH transmission
      is determined by the resource used for the PSCCH
      transmission containing the associated SCI format, and fields
      ′Time resource assignment′, ′time duration′ of the associated
      SCI format 1-A as described below.
        All the resources in the slots indicated by the ′time
        resource assignment′ field in the SCI
          TRIV calculation is omitted
        And all the resources in the slots indicated by the
        ′time duration′ field in the SCI
```

FIG. 9A illustrates an example of resource reservation indicated in SCI from other UE in accordance with some embodiments of the present disclosure. In FIG. 9A, the received SCI indicate that the same resources as those shown in FIG. 8A are reserved, but multiple UEs are allowed to access and perform transmission in one LBT BW(RB set or sub-band), i.e., multiple UEs are FDMed.

In some embodiments, as shown in FIG. 9B, the first terminal device 110 may only exclude the slots indicated by the time resource assignment and the frequency resource assignment and ignore the slots indicated by the slot duration field.

Alternatively or in addition, the first terminal device 110 may exclude the slots indicated by the time resource assignment and the frequency resource assignment and additionally exclude the whole slots indicated by the slot duration field, as shown in FIG. 9C.

Table 4 shows another example change in TS 38.214 associated with the resource exclusion.

```
TABLE 4
. . . omitted . . .
  The UE shall exclude any candidate single-slot resource R_{x,y} from
  the set S_{A} if it meets all the following conditions.
    a), b) are omitted
    $c ) the SCI format received in slot {t}_{m}^{′ SL} or the same SCI$
    format which, if and only if the ′Resource reservation period′
    field is present in the received SCI format 1-A, is assumed to
    $be received in slot ( s ) {t}_{m + q \times {P}_{rsvp \_ RX}^{′}}^{′ SL} determines according$
    to clause 8.1.5 the set of resource blocks and slots and the
    whole slots according to clause 8.1.5Y which overlaps with
    ${R}_{x , y + j \times {P}_{rsvp \_ TX}^{′}} for q = 1 , 2 , … , Q and j = 0 , 1 , … , {C}_{resel} - 1 . z$
    --omitted---
    Clause 8.1.5Y
      The set of slots for PSSCH transmission is determined by the
      resource used for the PSCCH transmission containing the
      associated SCI format, and fields ′time duration′ of the
      associated SCI format 1-A as described below.
        The consecutive slots following the slot containing the
        associated SCI and indicated by the ″time duration″
        field in the SCI
```

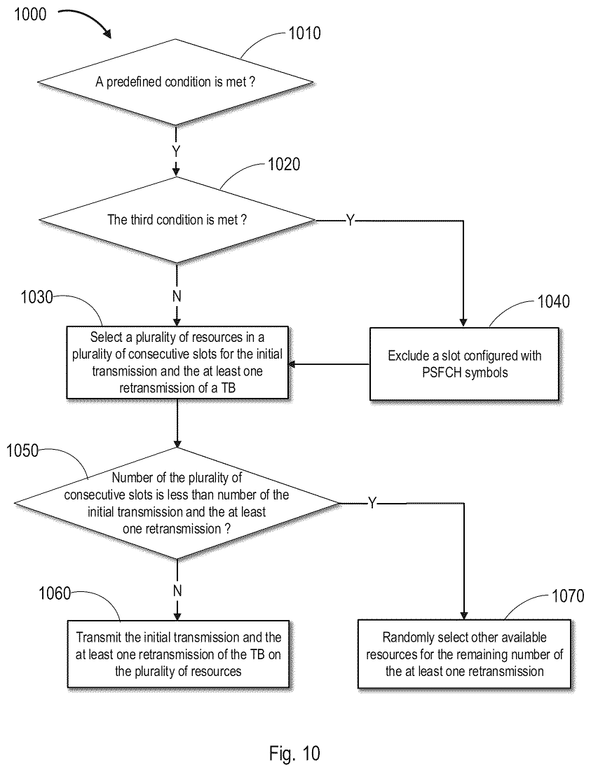

FIG. 10 illustrates a flowchart of an example method 100) of multi-slots transmission for a TB in accordance with some embodiments of the present disclosure. The method 1000 can be implemented at a terminal device, such as one of the first terminal device 110, the second terminal device 120 and the third terminal device 130 as shown in FIG. 1. For the purpose of discussion, the method 1000 will be described with reference to FIG. 1 as performed by the first terminal device 110 without loss of generality. In some embodiments, the first terminal device 110 performs resource selection for same TB's initial transmissions and one or more retransmissions.

As shown in FIG. 10, the first terminal device 110 determines, at 1010, whether a predefined condition is met. In some embodiments, the predefined condition comprises a first condition that the first terminal device is configured to perform blind retransmissions by a higher layer. Alternatively or in addition, the predefined condition comprises a second condition that a resource pool for the initial transmission and the at least one retransmission is configured with no Physical Sidelink Feedback Channel (PSFCH) resource by the higher layer. Alternatively or in addition, the predefined condition comprises a third condition that the resource pool is configured with PSFCH resources, but hybrid automatic repeat request-acknowledgement (HARQ-ACK) is disabled for the first terminal device by the higher layer.

If a predefined condition is met, the first terminal device 110 determines, at 1020, whether the third condition is met. If no, i.e., at least one of the first condition and the second condition is met, then, the first terminal device 110 determines that an initial transmission and at least one retransmission of a TB are allowed to be transmitted in consecutive slots, and selects, at 1030, a plurality of resources in a plurality of consecutive slots for the initial transmission and the at least one retransmission of the TB. The resources belongs to time-domain consecutive slots and are selected from available candidate resources reported from PHY layer.

If third condition is met, the first terminal device 110 excludes, at 1040, a slot configured with PSFCH symbols from the plurality of consecutive slots.

Then, at 1050, the first terminal device 110 determines whether the number of the plurality of consecutive slots is less than the number of the initial transmission and the at least one retransmission. If no, i.e., the plurality of consecutive slots is enough for the initial transmission and the at least one retransmission of the TB, then, the first terminal device 110 transmits, at 1060, the initial transmission and the at least one retransmission of the TB on the plurality of resources to another terminal device, such as the second terminal device 120 and the third terminal device 130.

If the number of the plurality of consecutive slots is less than the number of the initial transmission and the at least one retransmission, the first terminal device 110 randomly selects other available resources for the remaining number of the at least one retransmission.

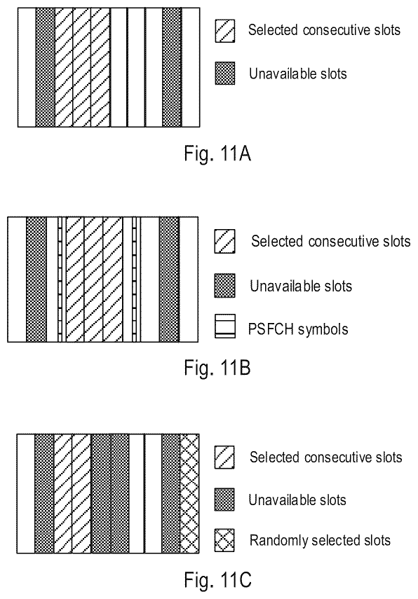

FIGS. 11A-11C illustrate examples of resource selections corresponding to the first, second and third conditions. FIG. 11A shows a resource selection in case of blind retransmission or the resource pool is configured with no PSFCH resources. FIG. 11B shows a resource selection in case where the resource pool is configured with PSFCH resource while HARQ-ACK is disable. FIG. 11C shows a resource selection in case where consecutive slots are less than the number of TB's (re-)transmission.

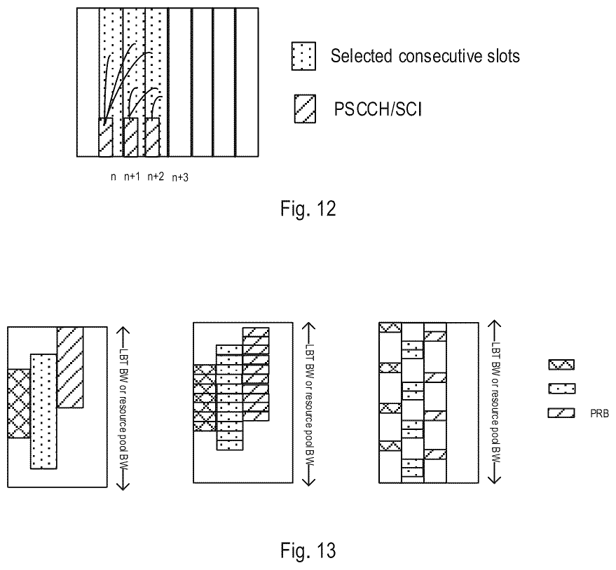

In some embodiments, when consecutive slots are used for a same TB's initial transmission and retransmissions, a SCI without a slot duration field can be used to indicate resource reservation. This will be described with reference to FIG. 12.

FIG. 12 illustrates an example of an SCI without a slot duration field indicating resources in consecutive slots in accordance with some embodiments of the present disclosure. In FIG. 12, the time resource assignment and the frequency resource assignment of a SCI indicate the resource of current (re-)transmission and subsequent retransmissions.

FIG. 13 illustrates the frequency resource distribution in a slot as used herein. For the resource illustration in the present disclosure, except saying “the whole slot” or “all frequency resource in the slot” which explicitly clarified the frequency resource is the whole LBT bandwidth (or RB set, sub-band), the other figures which occupy part frequency resource in a slot (such as the left figure in FIG. 13) could means either: part of Contiguous RBs in the slot (as shown in the middle figure in FIG. 13), or part of Interlaced RBs in the slot (as shown in the right figure in FIG. 13).

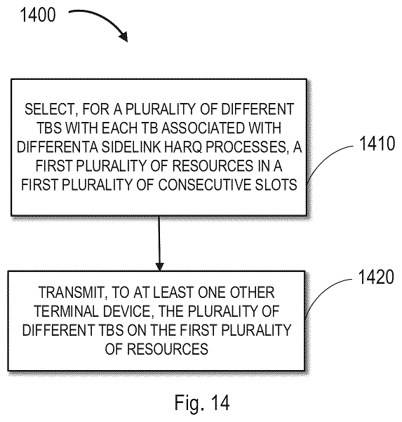

FIG. 14 illustrates a flowchart of an example method 1400 implemented at a terminal device in accordance with some embodiments of the present disclosure. The method 1400 can be implemented at a terminal device, e.g., the first terminal device 110 as shown in FIG. 1.

At block 1410, the first terminal device 110 selects for a plurality of different transport blocks (TBs) with each TB associated with a sidelink hybrid automatic repeat request (HARQ) process, a first plurality of resources in a first plurality of consecutive slots.

At block 1420, the first terminal device 110 transmits, to at least one other terminal device, the plurality of different TBs on the first plurality of resources.

In some embodiments, the first terminal device 110 may select, for the plurality of different TBs, a second plurality of resources in a second plurality of consecutive slots, and retransmit, to the at least one other terminal device, the plurality of different TBs on the second plurality of resources.

In some embodiments, the first terminal device 110 may transmit the plurality of different TBs to the at least one other terminal device belonging to different destinations. Alternatively or in addition, the first terminal device 110 may transmit the plurality of different TBs belonging to a same traffic to the at least one other terminal device belonging to a same destination.

In some embodiments, the first plurality of resources and the second plurality of resources may be selected based at least on a plurality of remaining packet delay budgets (PDB) of the plurality of different TBs.

In some embodiments, in response to a first resource of the first plurality of resources for a first TB of the plurality of different TBs has been selected, the first terminal device 110 may select a second resource of the first plurality of resources for a second TB of the plurality of different TBs as immediately preceding or following the first resource.

In some embodiments, in response to a third resource of the second plurality of resources for the first TB has been selected, the first terminal device 110 may select a fourth resource of the second plurality of resources for the second TB as immediately preceding or following the third resource.

In some embodiments, a first order of the first plurality of consecutive slots and a second order of the second plurality of consecutive slots may be consistent with a third order of a plurality of sidelink HARQ processes associated with the plurality of TBs.

In some embodiments, the first terminal device 110 may transmit sidelink control information (SCI) comprising a slot duration field in a slot of the first plurality of consecutive slots, the slot duration field indicating the number of consecutive slots of the first plurality of consecutive slots subsequent to the slot.

In some embodiments, a bit length of the slot duration field may be determined by a higher layer configuration. In addition, an allowed slot duration corresponding to each value of the slot duration field may be configured via a radio resource control (RRC) message.

In some embodiments, in response to transmitting the plurality of different TBs belonging to the same traffic to a plurality of terminal devices belongs to the same destination, the first terminal device 110 may transmit in the first one of the first plurality of consecutive slots, an SCI with a frequency resource assignment, a time resource assignment and a slot duration field. The frequency resource assignment and the time resource assignment may indicate frequency resources in the first one of the first plurality of consecutive slots. The slot duration field may indicate the number of the first plurality of consecutive slots. Frequency resources in each of the first plurality of consecutive slots may be consistent.

In some embodiments, the first terminal device 110 may sense, in a resource pool, an available candidate resource set from which the first plurality of resources are selected. In some embodiments, to sense the available candidate resource set, the first terminal device 110 may exclude at least one resource in the resource pool based at least on a SCI received from a second terminal device. The SCI may comprise a slot duration field indicating a third plurality of consecutive slots including resources reserved by the second terminal device.

In some embodiments, the first terminal device 110 may exclude all frequency resources in a slot indicated by a time resource assignment in the SCI and the third plurality of consecutive slots.

In some embodiments, the first terminal device 110 may exclude at least one resource indicated by a time resource assignment and a frequency resource assignment in the SCI.

In some embodiments, the first terminal device 110 may exclude the third plurality of consecutive slots.

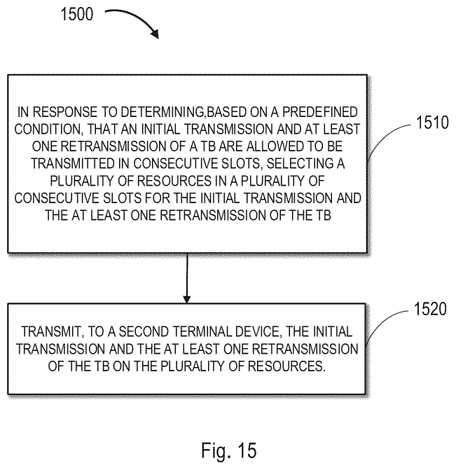

FIG. 15 illustrates a flowchart of an example method 1500 implemented at a terminal device in accordance with some embodiments of the present disclosure. The method 1500 can be implemented at a terminal device, e.g., the first terminal device 110 as shown in FIG. 1.

At block 1510, in response to determining, based on a predefined condition, that an initial transmission and at least one retransmission of a transport block (TB) are allowed to be transmitted in consecutive slots, the first terminal device 110 selects a plurality of resources in a plurality of consecutive slots for the initial transmission and the at least one retransmission of the TB.

In some embodiments, the predefined condition may comprise a first condition that the first terminal device is configured to perform blind retransmissions by a higher layer. Alternatively or in addition, the predefined condition may comprise a second condition that a resource pool for the initial transmission and the at least one retransmission is configured with no Physical Sidelink Feedback Channel (PSFCH) resource by the higher layer. Alternatively or in addition, the predefined condition may comprise a third condition that the resource pool is configured with PSFCH resources, but hybrid automatic repeat request-acknowledgement (HARQ-ACK) is disabled for the first terminal device by the higher layer.

At block 1520, the first terminal device 110 transmits, to a second terminal device, the initial transmission and the at least one retransmission of the TB on the plurality of resources.

In some embodiments, in response to the third condition being met, the first terminal device 110 may exclude a slot configured with PSFCH symbols from the plurality of consecutive slots.

In some embodiments, in response to determining that the number of the plurality of consecutive slots is less than the number of the initial transmission and the at least one retransmission, the first terminal device 110 may randomly select other available resources for the remaining number of the at least one retransmission.

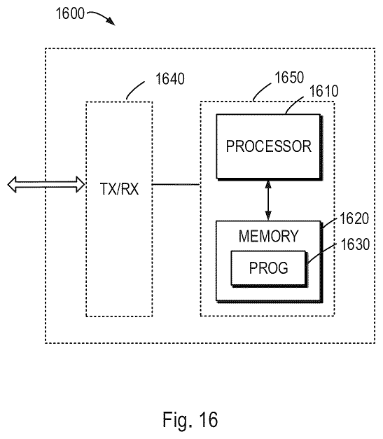

FIG. 16 is a simplified block diagram of a device 1600 that is suitable for implementing some embodiments of the present disclosure. The device 1600 can be considered as a further example embodiment of the first terminal device 110 as shown in FIG. 1. Accordingly, the device 1600 can be implemented at or as at least a part of the terminal device 110.

As shown, the device 1600 includes a processor 1610, a memory 1620 coupled to the processor 1610, a suitable transmitter (TX) and receiver (RX) 1640 coupled to the processor 1610, and a communication interface coupled to the TX/RX 1640. The memory 1620 stores at least a part of a program 1630. The TX/RX 1640 is for bidirectional communications. The TX/RX 1640 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1630 is assumed to include program instructions that, when executed by the associated processor 1610, enable the device 1600 to operate in accordance with the embodiments of the present disclosure, as discussed herein with reference to FIGS. 1 to 15. The embodiments herein may be implemented by computer software executable by the processor 1610 of the device 1600, or by hardware, or by a combination of software and hardware. The processor 1610 may be configured to implement various embodiments of the present disclosure. Furthermore, a combination of the processor 1610 and memory 1620 may form processing means 1650 adapted to implement various embodiments of the present disclosure.

The memory 1620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1620 is shown in the device 1600, there may be several physically distinct memory modules in the device 1600. The processor 1610 may be of any type suitable to the local technical network, and may include one or more of general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In summary, embodiments of the present disclosure may provide the following solutions.

A method for sidelink communication, comprises: selecting, at a first terminal device for a plurality of different transport blocks (TBs) with each TB associated with a sidelink hybrid automatic repeat request (HARQ) process, a first plurality of resources in a first plurality of consecutive slots; and transmitting, to at least one other terminal device, the plurality of different TBs on the first plurality of resources.

In some embodiments, the method further comprises: selecting, for the plurality of different TBs, a second plurality of resources in a second plurality of consecutive slots; and retransmitting, to the at least one other terminal device, the plurality of different TBs on the second plurality of resources.

In some embodiments, transmitting the plurality of different TBs comprises at least one of the following: transmitting the plurality of different TBs to the at least one other terminal device belonging to different destinations; or the plurality of different TBs belonging to a same traffic to the at least one other terminal device belonging to a same destination.

In some embodiments, the first plurality of resources and the second plurality of resources are selected based at least on a plurality of remaining packet delay budgets (PDB) of the plurality of different TBs.

In some embodiments, selecting the first plurality of resources comprises: in response to a first resource of the first plurality of resources for a first TB of the plurality of different TBs has been selected, selecting a second resource of the first plurality of resources for a second TB of the plurality of different TBs as immediately preceding or following the first resource.

In some embodiments, a first order of the first plurality of consecutive slots and a second order of the second plurality of consecutive slots are consistent with a third order of a plurality of sidelink HARQ processes associated with the plurality of TBs.

In some embodiments, the method further comprises: transmitting sidelink control information (SCI) comprising a slot duration field in a slot of the first plurality of consecutive slots, the slot duration field indicating the number of consecutive slots of the first plurality of consecutive slots subsequent to the slot.

In some embodiments, a bit length of the slot duration field is determined by a higher layer configuration, and an allowed slot duration corresponding to each value of the slot duration field is configured via a radio resource control (RRC) message.

In some embodiments, the method further comprises: in response to transmitting the plurality of different TBs belonging to the same traffic to a plurality of terminal devices belongs to the same destination, transmitting, in the first one of the first plurality of consecutive slots, an SCI with a frequency resource assignment, a time resource assignment and a slot duration field. The frequency resource assignment and the time resource assignment indicate frequency resources in the first one of the first plurality of consecutive slots, the slot duration field indicates the number of the first plurality of consecutive slots, and frequency resources in each of the first plurality of consecutive slots are consistent.

In some embodiments, the method further comprises: sensing, in a resource pool, an available candidate resource set from which the first plurality of resources are selected. Sensing the available candidate resource set comprises: excluding at least one resource in the resource pool based at least on a SCI received from a second terminal device, the SCI comprising a slot duration field indicating a third plurality of consecutive slots including resources reserved by the second terminal device.

In some embodiments, excluding the at least one resource comprises: excluding all frequency resources in a slot indicated by a time resource assignment in the SCI and the third plurality of consecutive slots.

In some embodiments, excluding the at least one resource comprises: excluding at least one resource indicated by a time resource assignment and a frequency resource assignment in the SCI.

In some embodiments, excluding the at least one resource further comprises: excluding the third plurality of consecutive slots.

A method for sidelink communication, comprises: in response to determining, at a first terminal device based on a predefined condition, that an initial transmission and at least one retransmission of a transport block (TB) are allowed to be transmitted in consecutive slots, selecting a plurality of resources in a plurality of consecutive slots for the initial transmission and the at least one retransmission of the TB; and transmitting, to a second terminal device, the initial transmission and the at least one retransmission of the TB on the plurality of resources.

In some embodiments, the predefined condition comprises at least one of: a first condition that the first terminal device is configured to perform blind retransmissions by a higher layer, a second condition that a resource pool for the initial transmission and the at least one retransmission is configured with no Physical Sidelink Feedback Channel (PSFCH) resource by the higher layer, or a third condition that the resource pool is configured with PSFCH resources, but hybrid automatic repeat request-acknowledgement (HARQ-ACK) is disabled for the first terminal device by the higher layer.

In some embodiments, the method further comprises: in response to the third condition being met, excluding a slot configured with PSFCH symbols from the plurality of consecutive slots.

In some embodiments, the method further comprises: in response to determining that the number of the plurality of consecutive slots is less than the number of the initial transmission and the at least one retransmission, randomly selecting other available resources for the remaining number of the at least one retransmission.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 16. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for sidelink communication, comprising:
selecting, at a first terminal device for a plurality of different transport blocks (TBs) with each TB associated with a sidelink hybrid automatic repeat request (HARQ) process, a first plurality of resources in a first plurality of consecutive slots; and
transmitting, to at least one other terminal device, the plurality of different TBs on the first plurality of resources.

2. The method of claim 1, further comprising:
selecting, for the plurality of different TBs, a second plurality of resources in a second plurality of consecutive slots; and
retransmitting, to the at least one other terminal device, the plurality of different TBs on the second plurality of resources.

3. The method of claim 2, wherein transmitting the plurality of different TBs comprises at least one of the following:
transmitting the plurality of different TBs to the at least one other terminal device belonging to different destinations; or
the plurality of different TBs belonging to a same traffic to the at least one other terminal device belonging to a same destination.

4. The method of claim 2, wherein the first plurality of resources and the second plurality of resources are selected based at least on a plurality of remaining packet delay budgets (PDB) of the plurality of different TBs.

5. The method of claim 2, wherein selecting the first plurality of resources comprises:
in response to a first resource of the first plurality of resources for a first TB of the plurality of different TBs has been selected, selecting a second resource of the first plurality of resources for a second TB of the plurality of different TBs as immediately preceding or following the first resource.

6. The method of claim 5, wherein selecting the second plurality of resources comprises:
in response to a third resource of the second plurality of resources for the first TB has been selected, selecting a fourth resource of the second plurality of resources for the second TB as immediately preceding or following the third resource.

7. The method of claim 2, wherein a first order of the first plurality of consecutive slots and a second order of the second plurality of consecutive slots are consistent with a third order of a plurality of sidelink HARQ processes associated with the plurality of TBs.

8. The method of claim 1, further comprising:
transmitting sidelink control information (SCI) comprising a slot duration field in a slot of the first plurality of consecutive slots, the slot duration field indicating the number of consecutive slots of the first plurality of consecutive slots subsequent to the slot.

9. The method of claim 8, wherein at least one of:
a bit length of the slot duration field is determined by a higher layer configuration, and
an allowed slot duration corresponding to each value of the slot duration field is configured via a radio resource control (RRC) message.

10. The method of claim 3, further comprising:
in response to transmitting the plurality of different TBs belonging to the same traffic to a plurality of terminal devices belongs to the same destination, transmitting, in the first one of the first plurality of consecutive slots, an SCI with a frequency resource assignment, a time resource assignment and a slot duration field, the frequency resource assignment and the time resource assignment indicating frequency resources in the first one of the first plurality of consecutive slots, the slot duration field indicating the number of the first plurality of consecutive slots, and frequency resources in each of the first plurality of consecutive slots being consistent.

11. The method of claim 1, further comprising:
sensing, in a resource pool, for an available candidate resource set from which the first plurality of resources are selected, wherein sensing for the available candidate resource set comprises:
excluding at least one resource in the resource pool based at least on a SCI received from a second terminal device, the SCI comprising a slot duration field indicating a third plurality of consecutive slots including resources reserved by the second terminal device.

12. The method of claim 11, wherein excluding the at least one resource comprises:
excluding all frequency resources in a slot indicated by a time resource assignment in the SCI and the third plurality of consecutive slots.

13. The method of claim 11, wherein excluding the at least one resource comprises:
excluding at least one resource indicated by a time resource assignment and a frequency resource assignment in the SCI.

14. The method of claim 13, wherein excluding the at least one resource further comprises:
excluding the third plurality of consecutive slots.

15. A method for sidelink communication, comprising:
in response to determining, at a first terminal device based on a predefined condition, that an initial transmission and at least one retransmission of a transport block (TB) are allowed to be transmitted in consecutive slots, selecting a plurality of resources in a plurality of consecutive slots for the initial transmission and the at least one retransmission of the TB; and
transmitting, to a second terminal device, the initial transmission and the at least one retransmission of the TB on the plurality of resources.

16. The method of claim 15, wherein the predefined condition comprises at least one of:
a first condition that the first terminal device is configured to perform blind retransmissions by a higher layer,
a second condition that a resource pool for the initial transmission and the at least one retransmission is configured with no Physical Sidelink Feedback Channel (PSFCH) resource by the higher layer, or
a third condition that the resource pool is configured with PSFCH resources, but hybrid automatic repeat request-acknowledgement (HARQ-ACK) is disabled for the first terminal device by the higher layer.

17. The method of claim 16, further comprising:
in response to the third condition being met, excluding a slot configured with PSFCH symbols from the plurality of consecutive slots.

18. The method of claim 15, further comprising:
in response to determining that the number of the plurality of consecutive slots is less than the number of the initial transmission and the at least one retransmission, randomly selecting other available resources for the remaining number of the at least one retransmission.

19. A terminal device, comprising:
a processor configured to perform the method according to any of claims 1-14 or any of claims 15-18.

20. A computer readable medium having instructions stored thereon, the instructions, when executed on at least one processor of a device, causing the device to carry out the method according to any of claims 1-14 or any of claims 15-18.
